(19) United States
(12) Patent Application Publication
(10) Pub. No.: US 2026/0187194 A1
(43) Pub. Date: Jul. 2, 2026

(54) INFORMATION PROCESSING METHOD, INFORMATION PROCESSING APPARATUS, AND NON-TRANSITORY COMPUTER-READABLE STORAGE MEDIUM STORING PROGRAM

(71) Applicant: Panasonic Intellectual Property Management Co., Ltd., Osaka (JP)

(72) Inventors: TATSUMI OBA, Chiba (JP); RIKIYA HIRAISHI, Aichi (JP); SEIYA KAMBAYASHI, Hyogo (JP)

(21) Appl. No.: 19/544,922

(22) Filed: Feb. 19, 2026

Related U.S. Application Data
(63) Continuation of application No. PCT/JP2024/016511, filed on Apr. 26, 2024.

(30) Foreign Application Priority Data
Aug. 29, 2023 (JP) 2023-139080

(51) Int. Cl. G06F 18/213; G06F 18/2413

(52) U.S. Cl. CPC G06F 18/213; G06F 18/24137

(57) ABSTRACT

An information processing method according to an aspect of the present disclosure obtains a packet flowing through a network and determines whether the obtained packet is abnormal on the basis of an operation image displayed on an operation apparatus at a time when the operation apparatus receives an operation for causing the operation apparatus to transmit the packet obtained through the network from a user using a graphical user interface (GUI) displayed on the operation apparatus.

### BACKGROUND

### 1. Technical Field

The present disclosure relates to techniques for detecting abnormal communication in a network.

### 2. Description of the Related Art

Conventionally, control apparatuses installed in factory facilities and the like have employed proprietary communication methods, and have been operated while communicating with other apparatuses through dedicated communication lines. In recent years, however, communication standards have been established between control apparatuses utilizing a general-purpose protocol such as Ethernet (registered trademark) or IP (Internet Protocol), which has been advanced in terms of speed and cost reduction along with the spread of the Internet.

In recent years, with the use of the general-purpose communication standards, control apparatuses have become increasingly exposed to the risk of cyberattacks, including malware. Accordingly, it has become common practice to attempt to monitor a control system network using an intrusion detection system (IDS) and to detect and respond to abnormal communication. In control systems, processing is basically performed automatically in accordance with predetermined logic, and traffic (data) necessary for such processing is also generated automatically, so that it is relatively easy to learn baseline behavior. Therefore, it is frequently the case that abnormal communication is detected by employing an IDS having a function of detecting abnormalities in such behavior.

Another method for detecting abnormalities in association with user operation information is described in International Publication No. 2022/249816. International Publication No. 2022/249816 discloses an apparatus that determines that a cyberattack has likely occurred if a user operation has not occurred when an abnormal packet is observed.

### SUMMARY

One non-limiting and exemplary embodiment provides an information processing method and the like capable of facilitating appropriate detection of abnormal packets.

In one general aspect, the techniques disclosed here feature an information processing method including receiving an operation for causing an operation apparatus to transmit a packet from a user using a graphical user interface displayed on the operation apparatus, obtaining an operation image displayed on the operation apparatus at a time when the operation is received, obtaining the packet flowing through a network, and determining, on a basis of the obtained operation image, whether the obtained packet is abnormal.

With the information processing method according to the aspect of the present disclosure and the like, it is possible to facilitate appropriate detection of abnormal packets.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating configuration of a control system in which an abnormality detection apparatus according to an embodiment is used;

FIG. 2 is a block diagram illustrating configuration of the abnormality detection apparatus according to the embodiment;

FIG. 3 is a diagram illustrating pair information regarding Internet protocol (IP) addresses for which the abnormality detection apparatus according to the embodiment is to detect abnormalities;

FIG. 4 is a diagram illustrating operation information used by an abnormality detector according to the embodiment;

FIG. 5 is a diagram illustrating metadata extracted by a metadata extractor according to the embodiment;

FIG. 6 is a diagram illustrating type definition rules for control packets according to the embodiment;

FIG. 7 is a diagram illustrating a control type identifier (ID) table stored in a main database corresponding to screen operations according to the embodiment;

FIG. 8 is a diagram illustrating packet metadata table stored in the main database corresponding to the screen operations according to the embodiment;

FIG. 9 is a diagram illustrating a screen operation information table stored in the main database corresponding to the screen operations according to the embodiment;

FIG. 10 is a diagram illustrating a method in which the abnormality detector according to the embodiment detects an abnormality in a control packet on the basis of operation information;

FIG. 11 is a flowchart illustrating an outline of a process performed by the abnormality detection apparatus according to the embodiment;

FIG. 12 is a flowchart illustrating a process for extracting a control type ID of a control packet according to the embodiment;

FIG. 13 is a flowchart illustrating a process for calculating an abnormality level according to the embodiment; and

FIG. 14 is a flowchart illustrating an information processing method performed by an information processing apparatus according to the embodiment.

### DETAILED DESCRIPTIONS

An embodiment of an aspect of the present disclosure will be described hereinafter with reference to the drawings. The embodiment described hereinafter is a specific example of the present disclosure. Therefore, values, shapes, components, arrangement and connection modes of the components, steps, order of the steps, and the like mentioned in the following embodiment are examples and are not intended to limit the present disclosure. Among the components in the following embodiment, ones not described in the independent claims are components that can be optionally added. The drawings are schematic diagrams, and are not necessarily strict illustrations.

In the present specification, for example, when describing “larger than a threshold” in contrast to “smaller than or equal to the threshold”, it is meant that a distinction is made on the basis of the threshold, and these expressions may be construed as “greater than or equal to a threshold” and “smaller than the threshold”, respectively.

### Embodiment

An abnormality detection apparatus according to an embodiment will be described hereinafter. The abnormality detection apparatus associates communication abnormalities and screen operations with each other.

### Configuration

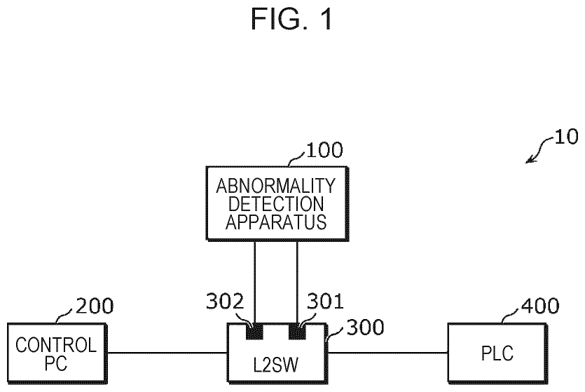

FIG. 1 is an example of a block diagram illustrating configuration of a control system 10 in which an abnormality detection apparatus 100 according to the embodiment is used. Specifically, FIG. 1 illustrates overall configuration of the control system 10 according to the present embodiment. In the present embodiment, each of apparatuses included in the control system 10 is assumed to perform communication using an appropriate protocol in accordance with characteristics of an application such as transmission control protocol/Internet protocol (TCP/IP) or user datagram protocol/Internet protocol (UDP/IP) in Ethernet specified by Institute of Electrical and Electronics Engineers (IEEE) 802.3.

First, components included in the control system 10 will be described.

As illustrated in FIG. 1, the control system 10 includes the abnormality detection apparatus 100, a control personal computer (PC) 200, a layer 2 switch (L2SW) 300 and a programmable logic controller (PLC) 400. The components of the control system 10 may be provided in a factory, for example, or at least a subset of the components may be provided outside the factory.

In a control network (e.g., a factory network) used by the apparatuses included in the control system 10 for communication, the apparatuses are connected to each other via the L2SW 300. The control PC 200 and the PLC 400 can communicate with each other via the L2SW 300. The control PC 200 is an apparatus for controlling production equipment in the factory.

The control PC 200 is a stationary PC, for example, but may be achieved by a tablet terminal or the like, instead. The control PC 200 is an example of an operation apparatus. For example, the control PC 200 includes a display device that displays an operation image (operation screen) for transmitting (generating) packets (control packets), an input device that receives operations (inputs) from a user, and a control device that performs processing for controlling images to be displayed on the display device and transmitting control packets to the PLC 400 on the basis of operations from the user received by the input device.

The display device is, for example, a display that displays images for allowing the user to perform operations, such as a graphical user interface (GUI).

The input device is a device for receiving operations from the user, such as a mouse and/or a keyboard. The input device may be achieved by a touch panel or the like, instead.

The control device is a computer that performs various types of information processing. The control apparatus includes, for example, a communication interface, such as a communication circuit, for communicating with an information processing apparatus and a controlled device over a network, a nonvolatile memory storing programs, a volatile memory, which is a temporary storage area for executing programs, input/output ports for transmitting and receiving signals, and a processor that executes programs.

The user transmits, to the PLC 400, control packets for controlling the PLC 400 (more specifically, control packets for allowing the PLC 400 to control the production equipment) by operating the control PC 200. Specifically, the user operates a GUI displayed on the control PC 200 to transmit a control packet to the PLC 400. At this time, the user transmits the control packet to the PLC 400 by, for example, performing an operation such as clicking the mouse to select an icon, such as a send button, in a GUI (specifically, an operation screen) displayed on the display device while looking at the GUI.

In the following description, for example, an operation performed by the user using the input device, such as clicking the mouse to select an icon such as a send button in an operation screen displayed on the display device while looking at the operation screen will be referred to as a “screen operation”. For example, in the present disclosure, a screen operation collectively refers to an input received on an operation screen displayed on the control PC 200, a click position in the operation screen, keyboard input information, and the like.

The PLC 400 is an apparatus for automatically controlling the production equipment in the factory, and controls the production equipment in accordance with predetermined order or procedure. Although not illustrated, the PLC 400 is communicably connected to the production equipment. The PLC 400 can control, for example, a plurality of motors, a plurality of actuators, and the like. Each of the plurality of motors and the plurality of actuators is provided with an object identifier (ID) for identification.

The PLC 400 is achieved by, for example, a communication interface for communication, such as a communication circuit, a nonvolatile memory storing programs, a volatile memory, which is a temporary storage area for executing programs, input/output ports for transmitting and receiving signals, a processor that executes programs, and the like.

The L2SW 300 is a relay in the control network that performs processing for transmitting obtained information to an apparatus according to the information. The L2SW 300 includes a mirror port 301 and a normal port 302.

The mirror port 301 is a port capable of capturing packets flowing through the network switch. The mirror port 301 is also called a “monitor port”. The L2SW 300 includes ports for connecting a large number of local area network (LAN) cables, and the mirror port 301 copies (mirrors) packets flowing through a specified port. In the present embodiment, the abnormality detection apparatus 100 is connected to the mirror port 301 and the normal port 302.

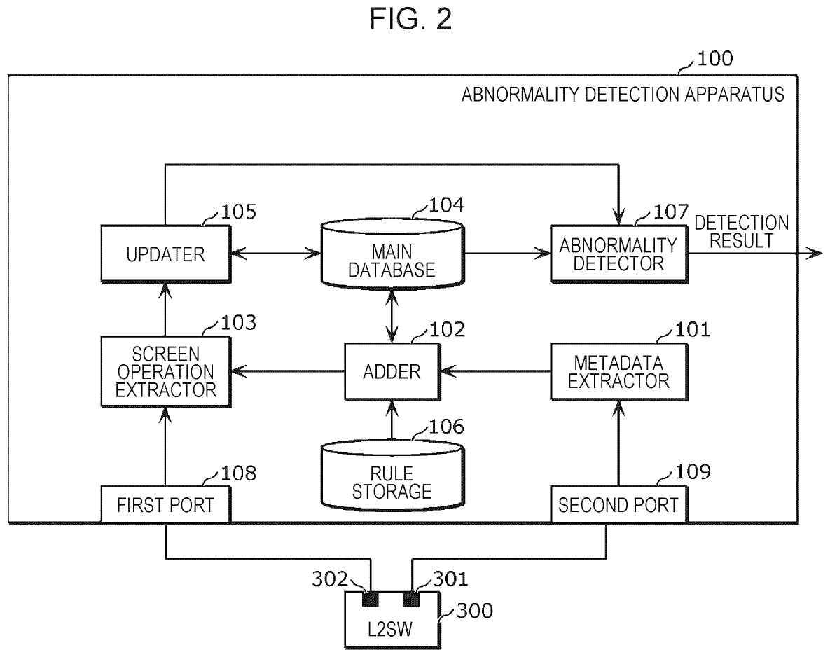

FIG. 2 is a block diagram illustrating configuration of the abnormality detection apparatus 100 according to the embodiment.

As illustrated in FIG. 2, the abnormality detection apparatus 100 includes a metadata extractor 101, an adder 102, a screen operation extractor 103, a main database 104, an updater 105, a rule storage 106, an abnormality detector 107, a first port 108, and a second port 109.

The abnormality detection apparatus 100 is achieved, for example, by a computer apparatus including a communication interface for communication, such as a communication circuit, a memory, and a processor that executes programs stored in the memory.

The metadata extractor 101 is a processing unit that observes control packets flowing through the control network via the second port 109. Specifically, the metadata extractor 101 obtains control packets flowing through the control network. More specifically, the metadata extractor 101 obtains metadata included in the obtained control packets. A specific example of the metadata will be described later. The metadata extractor 101 is an example of an obtainer.

The adder 102 is a processing unit that adds control type IDs to obtained control packets.

A control type ID is an identifier uniquely determined on the basis of information that can be included in a control packet, such as a source IP address, a destination IP address, and a command (control content) of the control packet. The control type ID is arbitrarily determined, for example, on the basis of a combination of these pieces of information. The adder 102 allocates a control type ID to an obtained control packet on the basis of data (metadata) included in the obtained control packet, and stores the control packet in the main database 104. A specific example of settings of the control type ID will be described later.

The screen operation extractor 103 is a processing unit that obtains information based on a screen operation by the user on the control PC 200. That is, the screen operation extractor 103 obtains information (operation information) regarding an operation (screen operation) performed by the user who operates the control PC 200 on the control PC 200. Specifically, the screen operation extractor 103 obtains information indicating a screen operation performed by the user on the control PC 200 via the first port 108.

For example, the screen operation extractor 103 obtains, as operation information, screenshots (screenshot images) at moments when the user clicks the mouse or performs key inputs (keyboard inputs). Specifically, the screen operation extractor 103 obtains operation information including a screenshot (also referred to as an “operation image”) of a GUI displayed on the display device included in the control PC 200 when the user clicks the mouse included in the control PC 200 or makes an input using the keyboard included in the control PC 200 as an operation on the control PC 200. For example, when the control PC 200 receives such an operation from the user, the control PC 200 obtains a time of the reception and a screenshot of a GUI displayed at this time as an operation image and transmits the time and the operation image to the abnormality detection apparatus 100.

The main database 104 is a storage device storing control packets to which control type IDs are allocated. Specifically, the main database 104 stores a control type ID table, which is a database in which control type IDs and pieces of data included in control packets are associated with each other.

The updater 105 is a processing unit that associates screen operations and control packets with each other. Specifically, the updater 105 associates obtained control packets and operation information with each other. More specifically, the updater 105 associates information regarding operations that have been performed by the user on the control PC 200 and that have been extracted by the screen operation extractor 103 and a plurality of pieces of metadata that has been included in control packets and that has been extracted by the metadata extractor 101 with each other.

For example, in the association, the updater 105 associates a control packet obtained by the metadata extractor 101 and operation information obtained by the screen operation extractor 103 within a specific period based on a time at which the control packet has been obtained with each other.

The specific period is determined as 1 second or shorter, for example, but may be arbitrarily determined in advance and is not particularly limited.

The control PC 200 may transmit operation information in association with a control packet. In this case, the updater 105 need not perform the association processing.

The rule storage 106 is a storage device storing information (also referred to as “type definition rules”) indicating definitions (rules) of types of control packets to be associated with screen operations. For example, the updater 105 determines, on the basis of the type definition rules, whether an obtained control packet is a control packet to be associated with a screen operation.

The abnormality detector 107 is a processing unit that detects abnormalities in observed communication. Specifically, the abnormality detector 107 detects abnormalities in control packets flowing through the control network. More specifically, the abnormality detector 107 obtains a control packet flowing through the control network and detects an abnormality in the obtained control packet.

The abnormality detector 107 is an example of a determiner.

In the present embodiment, when the control PC 200 receives an operation for causing the control PC 200 to transmit a control packet obtained through the network from the user using a GUI displayed on the control PC 200, the abnormality detector 107 determines whether the obtained control packet is abnormal on the basis of an operation image displayed on the control PC 200. That is, the abnormality detector 107 determines whether the obtained control packet is abnormal on the basis of an operation image displayed on the control PC 200 when the control PC 200 receives an operation for causing the control PC 200 to transmit the control packet from the user.

For example, in the determination of whether a control packet is abnormal, the abnormality detector 107 extracts a feature vector representing a feature of an operation image. The abnormality detector 107 then determines, for example, whether the obtained control packet is abnormal on the basis of a feature vector included in a screen operation information table and the extracted feature vector.

The screen operation information table is information indicating relationships between operations for causing the control PC 200 to transmit a control packet and feature vectors representing features of images displayed on the control PC 200 at times when the control PC 200 receives the operations from the user using GUIs displayed on the control PC 200.

The screen operation information table is an example of an image information table.

The screen operation information table may store, in association, operations for causing the control PC 200 to transmit a control packet and images displayed on the control PC 200 at a time when the control PC 200 receives the operations from the user using a GUI displayed on the control PC 200. In this case, the abnormality detector 107 may calculate, using the images, feature vectors, which represent features of the images.

An operation image is, for example, the screenshot described above, and is image data included in operation information.

In the determination of whether a control packet is abnormal, for example, the abnormality detector 107 determines that the obtained control packet is abnormal if a distance d to a feature vector, among a plurality of feature vectors included in the screen operation information table, that is closest to the extracted feature vector, is larger than a predetermined threshold T. If the distance d is smaller than or equal to the threshold T, on the other hand, for example, the abnormality detector 107 determines that the obtained control packet is not abnormal (i.e., the obtained control packet is normal).

The threshold T may be arbitrarily determined, and is not particularly limited. Information indicating the threshold T is, for example, stored in advance in a storage device included in the abnormality detection apparatus 100.

For example, each of the plurality of feature vectors (features) included in the screen operation information table is associated with a control type ID indicating a type of control packet associated therewith. In the determination of whether a control packet is abnormal, for example, if variation of one or more feature vectors associated with the same control type ID among the plurality of feature vectors included in the screen operation information table is larger than a predetermined variation, the abnormality detector 107 determines whether the obtained control packet is abnormal without using the one or more feature vectors associated with the same control type ID. In the determination of whether a control packet is abnormal, if variation of one or more feature values associated with the same control type ID is smaller than or equal to the predetermined variation, on the other hand, for example, the abnormality detector 107 determines whether the obtained control packet is abnormal using the one or more feature vectors associated with the same control type ID. In the determination of whether a control packet is abnormal, for example, the abnormality detector 107 calculates variation of one or more feature vectors associated with the same control type ID by calculating an average of values (specifically, real numbers) obtained by raising the distances d of the one or more feature vectors from a centroid vector of the one or more feature vectors to a power of N (N is a value larger than 0).

The predetermined variation may be arbitrarily determined, and is not particularly limited. Information indicating the predetermined variation is, for example, stored in advance in the storage device included in the abnormality detection apparatus 100.

The abnormality detector 107 outputs a determination result (detection result) of an abnormality of the control packet. The abnormality detector 107 may transmit the detection result to the control PC 200, output the detection result to a display device connected to the abnormality detection apparatus 100 to display the detection result, or transmit the detection result to an apparatus that analyzes control packets.

The first port 108 is connected to the normal port 302, and is a communication interface for obtaining control packets. The first port 108 is achieved, for example, by a connector or the like to which a communication line is connected. The first port 108 may be achieved by a communication circuit or the like for wireless communication, instead.

The second port 109 is connected to the mirror port 301, and is a communication interface for obtaining control packets. The second port 109 is achieved, for example, by a connector or the like to which a communication line is connected. The second port 109 may be achieved by a communication circuit or the like for wireless communication, instead.

The processing units such as the metadata extractor 101, the adder 102, the screen operation extractor 103, the updater 105, and the abnormality detector 107 are achieved, for example, by a memory storing a control program and a processor, such as a central processing unit (CPU), that executes the control program. The processor of the processing units may be achieved by one memory and one processor, or may be achieved by different memories and processors.

The storage devices such as the main database 104 and the rule storage 106 are achieved, for example, by a storage device such as a hard disk drive (HDD) or a semiconductor memory. The storage devices may be achieved by one storage device, or may be achieved by different storage devices.

Next, processing performed by each processing unit included in the abnormality detection apparatus 100 will be specifically described.

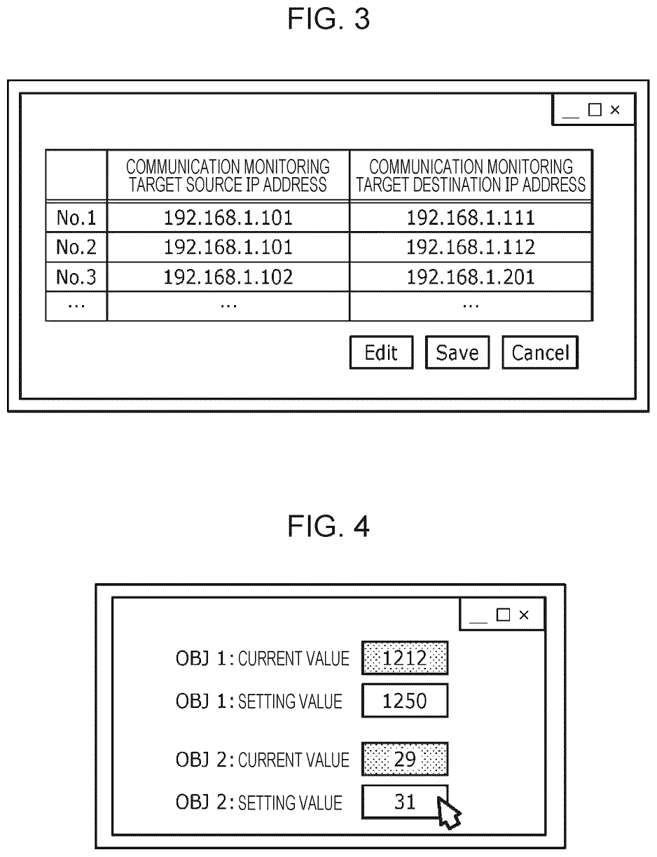

FIG. 3 is a diagram illustrating pair information regarding IP addresses for which the abnormality detection apparatus 100 according to the embodiment is to detect abnormalities (communication monitoring targets). Specifically, FIG. 3 illustrates communication monitoring target IP address information used by the adder 102. For example, FIG. 3 illustrates IP addresses of apparatuses to be monitored by the abnormality detection apparatus 100. Setting information indicating such IP addresses is, for example, stored in advance in the storage device included in the abnormality detection apparatus 100.

For example, packets for which the abnormality detection apparatus 100 stores screen operations and detects abnormalities are limited to communication between the IP addresses illustrated in FIG. 3.

FIG. 4 is a diagram illustrating operation information (screen operation information) used by the abnormality detector 107 according to the embodiment. FIG. 4 is a diagram illustrating an image extracted by the screen operation extractor 103 according to the embodiment. Specifically, FIG. 4 illustrates an example of operation information extracted by the screen operation extractor 103.

As illustrated in FIG. 4, it is assumed in the present disclosure that the control system 10 is controlled through screen operations. It is therefore assumed that a screen displayed by the control PC 200 shows control target items, setting values such as control values, and the like. A method for obtaining a screen operation may be, for example, a method in which a keylogger is installed on the control PC 200 and a displayed screen is captured at a timing when a screen operation is to be obtained and the captured display screen is transmitted to the abnormality detection apparatus 100.

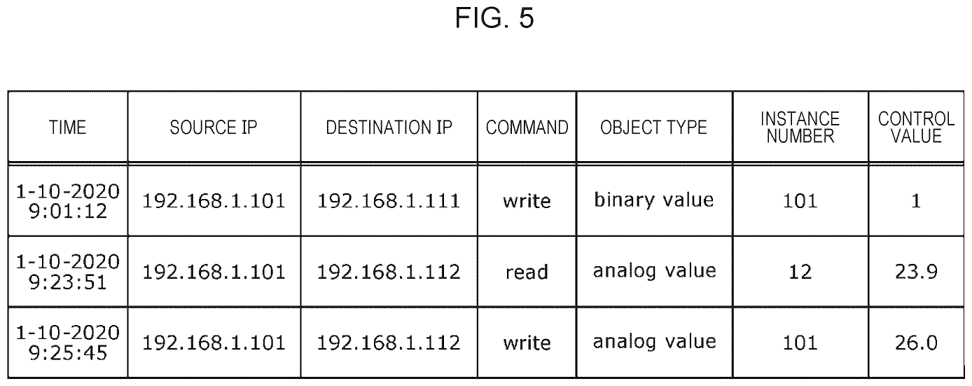

FIG. 5 is a diagram illustrating metadata (packet metadata) extracted by the metadata extractor 101 according to the embodiment.

As illustrated in FIG. 5, metadata included in a control packet includes information such as a time, a source IP address, a destination IP address, a command type, a type of object to be controlled (object type), an instance number of the object, and an obtained control value.

The object type is information indicating what kind of value is handled.

The instance number is information indicating order of an object set for each object.

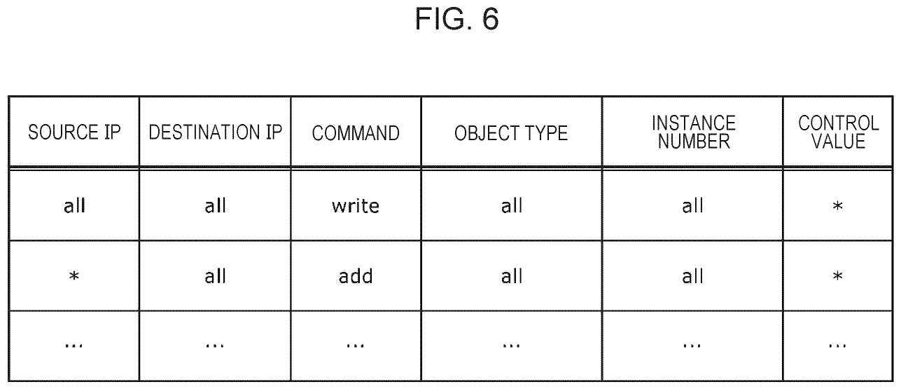

FIG. 6 is a diagram illustrating the type definition rules for control packets according to the embodiment. Specifically, FIG. 6 is a diagram illustrating an example of the type definition rules for control packets to be associated with the screen operations, the rules for which are stored in the rule storage 106.

As illustrated in FIG. 6, the control packets to be associated with the screen operations are, for example, limited to ones whose command types are “write” or “add”. For example, the updater 105 allocates control type IDs in accordance with the type definition rules.

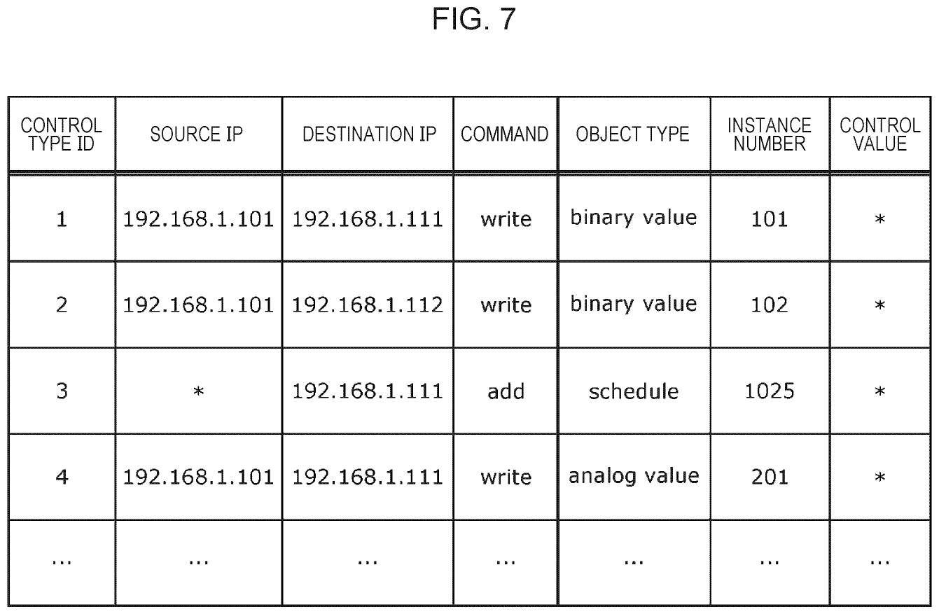

Note that “all” and “*” in FIG. 6 also indicate that control packets having any parameters with these attributes are to be associated with the screen operations. In the case of “all”, all values in a corresponding parameter are distinguished from each other. In the case of “*”, on the other hand, all values in a corresponding parameter are not distinguished from each other. As a result, differences are caused in a control type ID table illustrated in FIG. 7.

The type definition rules are, for example, the following (A) and (B).
(A) When an obtained control packet satisfies one of conditions of the type definition rules and a control type ID corresponding to the control packet has not already been allocated to the control packet (e.g., there is no control type ID yet), the adder 102 newly generates a control type ID, and associates attribute values of the obtained control packet (metadata included in the control packet) with the control type ID.
(B) When an obtained control packet satisfies one of the conditions of the type definition rules for control packets, the adder 102 simply allocates a corresponding control type ID to the control packet (more specifically, metadata included in the control packet).

It is assumed, however, that the type definition rules do not match conditions associated with a plurality of control type IDs.

The control type ID may be determined in advance, for example, on the basis of a combination of these pieces of information.

FIG. 7 is a diagram illustrating a control type ID table stored in the main database 104 corresponding to the screen operations according to the embodiment. Specifically, FIG. 7 is a diagram illustrating a control type ID table that is generated in accordance with the type definition rules and that is stored in the main database 104.

As illustrated in FIG. 7, a control type ID is added each time a control packet that has a newly obtained attribute and that satisfies the type definition rules is obtained.

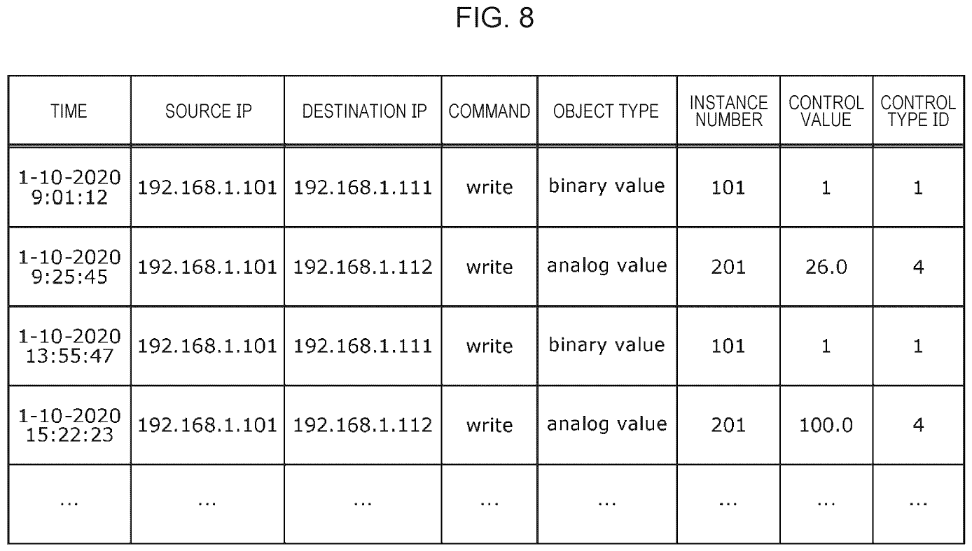

FIG. 8 is a diagram illustrating a packet metadata table stored in the main database 104 corresponding to the screen operations according to the embodiment. Specifically, FIG. 8 is a diagram illustrating a packet metadata table including a control type ID to which each control packet belongs.

The adder 102 adds a control type ID to metadata of each of control packets extracted by the metadata extractor 101 while referring to information in the control type ID table stored in the main database 104, and returns the control type ID of the control packet to the main database 104. The main database 104 updates the packet metadata table by adding a control type ID added by the adder 102 to metadata included in a control packet whose control type ID is still unknown.

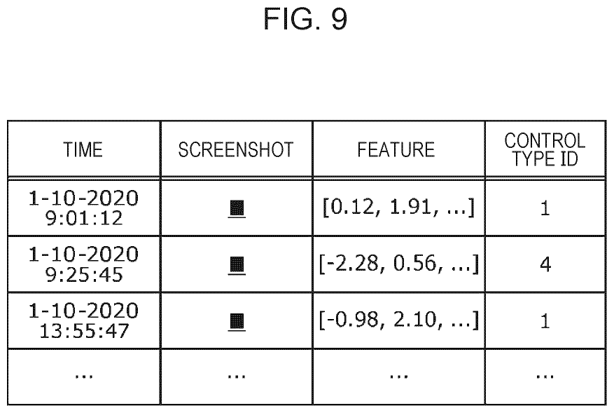

FIG. 9 is a diagram illustrating the screen operation information table stored in the main database 104 corresponding to the screen operations according to the embodiment.

When a screen operation (operation information) associated with a control packet included in the packet metadata table is extracted, the updater 105 adds a new record to the screen operation information table illustrated in FIG. 9, and records a control type ID to which the control packet belongs and operation information indicating the screen operation.

The screen operation information table may include a feature of an operation image (screenshot) included in operation information. For example, the updater 105 calculates a feature vector representing a feature of an operation image by performing image processing on the operation image. The abnormality detector 107 may calculate the feature vector, instead.

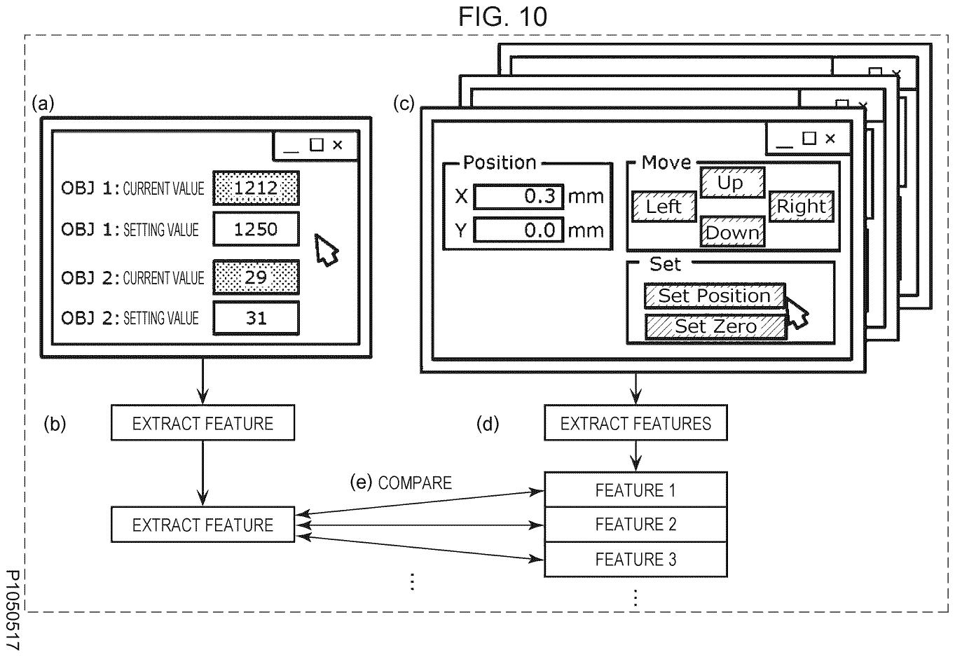

FIG. 10 is a diagram illustrating a method in which the abnormality detector 107 according to the embodiment detects an abnormality on the basis of operation information.

As illustrated in FIG. 10(a), the screen operation extractor 103 obtains operation information at a time when a control packet output by an abnormality detection target is obtained.

As illustrated in FIG. 10(b), the abnormality detector 107 extracts a feature of an operation image included in the operation information.

As illustrated in FIG. 10(c), the abnormality detector 107 extracts a control type ID indicated by the control packet, and extracts one or more operation images in the screen operation information table associated with the same control type ID extracted in the past.

As illustrated in FIG. 10(d), the abnormality detector 107 extracts a feature of each of the one or more extracted operation images. As a result, for example, a feature is extracted from each of the one or more operation images, such as “feature 1” extracted from “operation image 1” and “feature 2” extracted from “operation image 2”.

As illustrated in FIG. 10(e), the abnormality detector 107 compares a feature (feature vector) calculated from the obtained operation image and the extracted feature (feature vector). Specifically, the abnormality detector 107 extracts, among one or more features extracted from the screen operation information table, a feature closest to the feature extracted from the operation image included in the operation information associated with the obtained control packet. The abnormality detector 107 also determines whether a distance d between the feature vector calculated from the obtained operation image and the extracted closest feature vector is larger than the threshold T. If the distance d between the feature vector calculated from the obtained operation image and the extracted closest feature vector is larger than the threshold T, for example, the abnormality detector 107 detects the control packet and a screen operation indicated by the operation information associated with the control packet as an abnormality.

### Processing Procedure

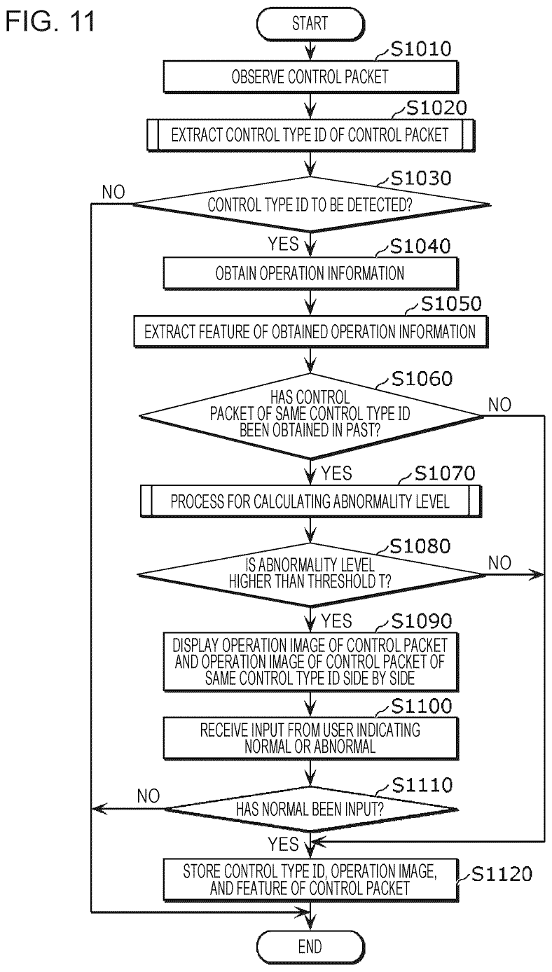

FIG. 11 is a flowchart illustrating an outline of a process performed by the abnormality detection apparatus 100 according to the embodiment.

As illustrated in FIG. 11, first, the abnormality detection apparatus 100 starts a process for detecting an abnormality and starts to observe a control packet (S1010). For example, the metadata extractor 101 and the screen operation extractor 103 start to obtain a control packet flowing through the control network and operation information.

Next, the adder 102 extracts a control type ID of the obtained control packet (S1020). For example, if a condition is satisfied, the adder 102 associates the control type ID with the obtained control packet, and stores the control packet in the main database 104. That is, the adder 102 adds the control type ID to the obtained control packet.

Next, the adder 102 determines whether the extracted control type ID is a control type ID for which an abnormality is to be detected (S1030).

If the adder 102 determines that the extracted control type ID is not a control type ID for which an abnormality is to be detected (NO in S1030), the abnormality detection apparatus 100 ends the process. In this case, the abnormality detection apparatus 100 waits until a control packet is observed next.

If the adder 102 determines that the extracted control type ID is a control type ID for which an abnormality is to be detected (YES in S1030), on the other hand, the screen operation extractor 103 performs processing for obtaining operation information immediately after the control packet occurs (i.e., immediately after the control packet is obtained) (S1040). As a result, the screen operation extractor 103 obtains operation information associated with the obtained control packet. Specifically, the screen operation extractor 103 obtains an operation image displayed on the control PC 200 at a time when the control PC 200 receives an operation for causing the control PC 200 to transmit the obtained control packet from the user using a GUI displayed on the control PC 200.

Next, the updater 105 extracts a feature (specifically, a feature vector) of the operation image included in the obtained operation information using a neural network whose input is the obtained operation information (S1050).

Next, the updater 105 determines whether a control packet associated with the same control type ID as the control type ID associated with the obtained control packet has been obtained in the past (S1060).

If determining that a control packet associated with the same control type ID as the control type ID associated with the obtained control packet has not been obtained in the past (NO in S1060), the updater 105 writes the control type ID associated with the obtained control packet, the operation image indicating the screen operation included in the operation information associated with the control packet, and the extracted feature to the screen operation information table stored in the main database 104 to store these pieces of information in the main database 104 (S1120), and ends the process.

If the updater 105 determines that a control packet associated with the same control type ID as the control type ID associated with the obtained control packet has been obtained in the past (YES in S1060), on the other hand, the abnormality detector 107 performs a process for calculating an abnormality level (S1070).

If, as a result of the processing in step S1070, the calculated abnormality level is lower than or equal to the threshold T (NO in S1080), the abnormality detector 107 determines that the obtained control packet is normal, and causes the process to proceed to step S1120.

If, as a result of the processing in step S1070, the calculated abnormality level is higher than the threshold T (YES in S1080), on the other hand, the abnormality detector 107 determines that the obtained control packet is abnormal. In this case, the abnormality detector 107 outputs the operation image included in the operation information obtained immediately after the obtained control packet has occurred and an operation image included in operation information immediately after the control packet that is associated with the same control type ID as the control type ID associated with the obtained control packet and that has been obtained in the past has occurred. That is, if determining that the control packet is abnormal, the abnormality detector 107 outputs the operation image associated with the control packet and the operation image associated with the control packet having the same control type ID as the control packet. By outputting these operation images to the display device included in the abnormality detection apparatus 100, for example, the abnormality detector 107 displays the operation images on the display device side by side (S1090).

Next, the abnormality detector 107 receives an input result of a determination from the user indicating whether the obtained control packet is normal or abnormal (S1100). The user views the two displayed operation images, determines whether the obtained control packet is certainly abnormal, and inputs a result. The abnormality detection apparatus 100 includes, for example, an input device such as a mouse and/or a keyboard in order to receive an input from the user. The abnormality detector 107 receives the input from the user via the input device.

These operation images may be output to the control PC 200, and the control PC 200 may receive an input result of a determination from the user indicating whether the obtained control packet is normal or abnormal.

If a result indicating that the obtained control packet is normal is input (YES in S1110), the updater 105 adds, in step S1120, the currently extracted operation information and feature to the screen operation information table as normal data, and ends the process. As a result, even if the detected information is erroneous, it is possible to provide feedback indicating that the detected information is erroneous.

If a result indicating that the obtained control packet is abnormal is input (NO in S1110), on the other hand, the updater 105 ends the process without performing step S1120, that is, ends the process while determining that the currently extracted operation information and feature are abnormal data, without adding these pieces of information to the screen operation information table.

As a result, the screen operation information table stores (updates) the operation information and the feature in a case where the control packet is normal.

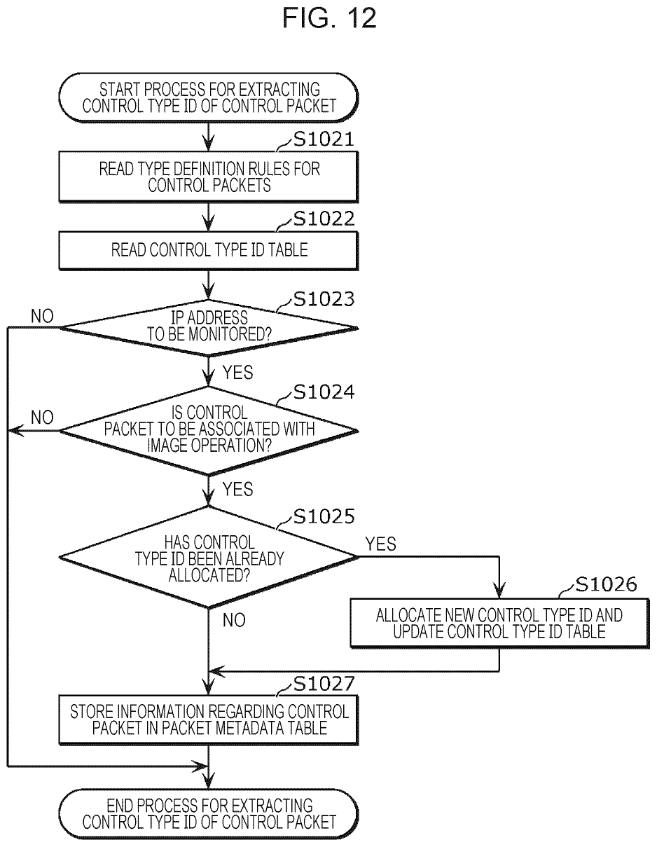

FIG. 12 is a flowchart illustrating a process for extracting a control type ID of a control packet according to the embodiment. Specifically, FIG. 12 is a flowchart illustrating details of the processing in step S1020.

As illustrated in FIG. 12, the adder 102 starts the process for extracting a control type ID of a control packet and reads the type definition rules for control packets stored in the rule storage 106 (S1021).

Next, the adder 102 reads the control type ID table stored in the main database 104 (S1022).

Next, the adder 102 determines, on the basis of the type definition rules, whether the obtained control packet has an IP address to be monitored (S1023).

If the obtained control packet has an IP address to be monitored (YES in S1023), the adder 102 determines whether the obtained control packet is a control packet to be associated with a screen operation (S1024).

If determining that the obtained control packet is a control packet to be associated with a screen operation (YES in S1024), the adder 102 determines whether a control type ID associated with the obtained control packet has already been allocated to a control packet obtained in the past (S1025).

If determining that the control type ID associated with the obtained control packet has already been allocated to a control packet obtained in the past (YES in S1025), the adder 102 updates the control type ID table by allocating a new control type ID to the obtained control packet (S1026).

If determining that the control type ID associated with the obtained control packet has not already been allocated to a control packet obtained in the past (NO in S1025), or after step S1026, the adder 102 stores information regarding the obtained control packet (e.g., metadata included in the control packet) in the packet metadata table (S1027), and ends the process for extracting a control type ID of a control packet.

If determining that the obtained control packet does not have an IP address to be monitored (NO in S1023), or if determining that the obtained control packet is not a control packet to be associated with a screen operation (NO in S1024), the adder 102 ends the process for extracting a control type ID of a control packet.

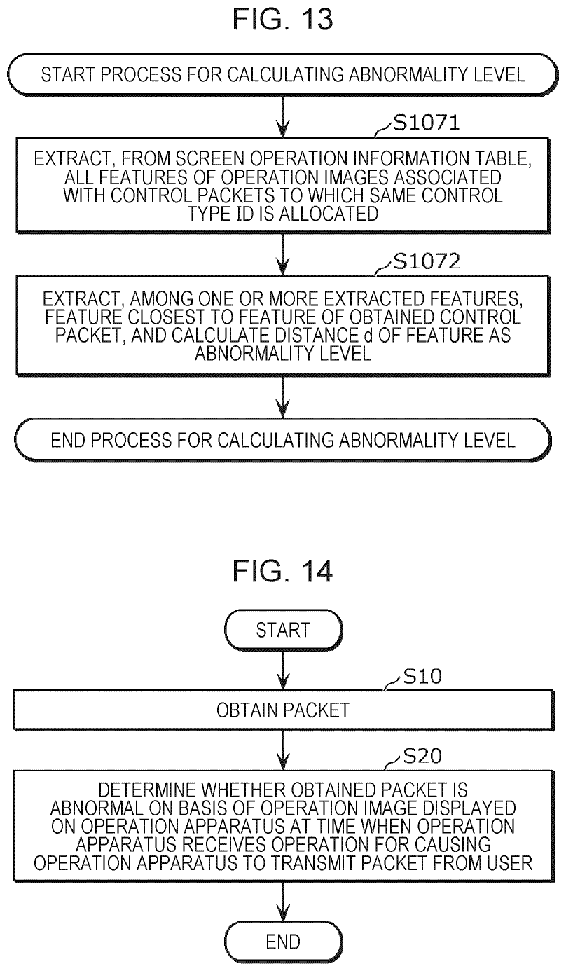

FIG. 13 is a flowchart illustrating the process for calculating an abnormality level according to the embodiment. Specifically, FIG. 13 is a flowchart illustrating details of the processing in step S1070.

As illustrated in FIG. 13, first, the abnormality detector 107 extracts, from the screen operation information table, all features of operation images included in operation information associated with control packets to which the same control type ID as the control type ID allocated to the control packet observed (obtained) in step S1010 is allocated (S1071).

Next, the abnormality detector 107 extracts, among the one or more extracted features, a feature closest to a feature of an operation image included in operation information associated with the obtained control packet, and calculates the distance d of the feature as an abnormality level (S1072). Specifically, the abnormality detector 107 calculates distances between a feature of an operation image immediately after the obtained control packet occurs, the feature having been extracted in step S1050, and all the features extracted in step S1071, finds a feature with the smallest distance, and calculates the smallest distance as the abnormality level.

### Summary

FIG. 14 is a flowchart illustrating an information processing method performed by an information processing apparatus according to the embodiment.

The information processing apparatus is, for example, the abnormality detection apparatus 100.

First, the information processing apparatus obtains a packet flowing through the network (S10). For example, the information processing apparatus obtains a packet transmitted to a controlled device over a network. The network is, for example, the control network described above. The controlled device is, for example, the PLC 400 described above. The packet is, for example, the control packet described above, and is a packet transmitted to the controlled device in order to control the controlled device. For example, the information processing apparatus obtains (observes) a packet in a network to which the controlled device is connected.

Next, when the operation apparatus receives an operation for causing the operation apparatus to transmit the packet obtained through the network from the user using a GUI displayed on the operation apparatus, the information processing apparatus determines whether the obtained packet is abnormal on the basis of an operation image displayed on the operation apparatus (S20). That is, when it is assumed that the operation apparatus transmits the obtained packet over the network, the information processing apparatus determines whether the packet is abnormal on the basis of an operation image indicating a displayed screen estimated to have been displayed on the operation apparatus at a time when the operation apparatus has received an operation for causing the operation apparatus to transmit the packet from the user using a GUI displayed on the operation apparatus.

The operation apparatus is, for example, the control PC 200.

The user transmits a packet to the controlled device by operating the operation apparatus. At this time, the user transmits a packet to the controlled device by, for example, performing an operation such as clicking the mouse to select an icon such as a send button in a GUI (displayed screen) displayed on the display device using the input device while looking at the GUI.

A packet for causing the controlled device to perform abnormal control might be transmitted to the controlled device by, for example, a malicious third party. In addition, for example, a packet transmitted from the operation apparatus might be falsified such that the controlled device performs abnormal control, and transmitted to the controlled device. The information processing apparatus detects such abnormal packets.

When malware or the like controls the control system 10, a user operation usually does not occur. It is therefore likely to be able to detect an abnormality in a packet on the basis of a difference between information included in a user operation (screen operation) and information included in an obtained packet.

On the basis of this idea, in the present disclosure, when a packet is obtained, the information processing apparatus determines whether there is a difference between a screen usually displayed on the operation apparatus when the packet occurs and information included in the packet, such as a control value. As a result, by observing information regarding a screen operation immediately after communication (packet) occurs, abnormality of the communication (packet) can be detected.

In addition, with the information processing apparatus, a screen operation (GUI operation) for causing a packet detected as an abnormality can be easily recognized, and an analysis at a security operation center (SOC) and the like can be efficiently performed.

The information processing apparatus may transmit a result of detection of an abnormality to the operation apparatus, the display device connected to the information processing apparatus, or the apparatus that analyzes packets.

The information processing apparatus includes a processor and a memory, for example, and the processor performs the information processing method using the memory.

### Effects

The techniques obtained from the disclosure of the present specification will be described as examples, and effects produced from the described techniques and the like will be described.

Technique 1 is an information processing method including obtaining a packet flowing through a network (S10) and determining whether the obtained packet is abnormal on the basis of an operation image displayed on an operation apparatus at a time when the operation apparatus receives an operation for causing the operation apparatus to transmit the packet obtained through the network from a user using a graphical user interface displayed on the operation apparatus (S20).

With this configuration, whether there is a difference between information included in a packet and information that is included in an operation image and that indicates what kind of operation has been performed by a user to cause the operation apparatus to transmit the packet can be determined. If there is a difference between the information included in the packet and the information that is included in the operation image and that indicates what kind of operation has been performed by the user to cause the operation apparatus to transmit the packet, for example, the packet might have been falsified by a cyberattack from a third party. With the information processing method according to the aspect of the present disclosure, therefore, it is possible to facilitate appropriate detection of abnormal packets. Because a cause of occurrence of an abnormal packet can be easily identified, the amount of processing in an analysis of an abnormality and the like can be reduced. The analysis of an abnormality can also be promptly performed.

Technique 2 is the information processing method according to technique 1, in which the determining extracts a feature vector representing a feature of the operation image and determines, on a basis of feature vectors included in an image information table and the extracted feature vector, whether the obtained packet is abnormal, and in which the image information table is information indicating relationships between operations for causing the operation apparatus to transmit a packet and feature vectors representing features of images displayed on the operation apparatus at times when the operation apparatus receives the operations from the user using graphical user interfaces displayed on the operation apparatus.

With this configuration, whether an obtained packet is abnormal can be appropriately determined using the packet, an obtained operation image, and the image information table.

Technique 3 is the information processing method according to technique 2, in which the determining determines that the obtained packet is abnormal if a distance to, among a plurality of feature vectors included in the image information table, a feature vector closest to the extracted feature vector is larger than a predetermined threshold.

With this configuration, whether an obtained packet is abnormal can be appropriately determined.

Technique 4 is the information processing method according to technique 2 or 3, in which a plurality of feature vectors included in the image information table is each associated with a control type identifier indicating a type of packet associated with the feature vector, and in which, if variation of, among the plurality of feature vectors, one or more feature vectors associated with a same control type identifier is larger than a predetermined variation, the determining determines whether the obtained packet is abnormal without using the one or more feature vectors associated with the same control type identifier.

When the variation is large, the same packet might be transmitted by different inputs from the user. If the variation calculated as described above is large, therefore, a corresponding feature vector is not used to determine an abnormality. As a result, it is possible to suppress a decrease in accuracy of the determination.

Technique 5 is the information processing method according to technique 4, in which, if the variation of the one or more feature vectors associated with the same control type identifier is smaller than or equal to the predetermined variation, the determining determines whether the obtained packet is abnormal using the one or more feature vectors associated with the same control type identifier.

With this configuration, the accuracy of the determination can be improved.

Technique 6 is the information processing method according to technique 4 or 5, in which the determining calculates the variation of the one or more feature vectors by calculating an average of values obtained by raising distances of the one or more feature vectors associated with the same control type identifier from a centroid vector of the one or more feature vectors to a power of N (N is a real number larger than 0).

With this configuration, the variation can be accurately calculated.

Technique 7 is an information processing apparatus including a receiver that receives an operation for causing an operation apparatus to transmit a packet from a user using a graphical user interface displayed on the operation apparatus, an obtainer that obtains an operation image displayed on the operation apparatus at a time when the operation is received, another obtainer that obtains the packet flowing through a network; and a determiner that determines, on a basis of the obtained operation image, whether the obtained packet is abnormal.

The obtainer is, for example, the metadata extractor 101. The determiner is, for example, the abnormality detector 107.

With this configuration, the same effects produced by the information processing method according to the aspect of the present disclosure can be produced.

Technique 8 is a non-transitory computer-readable storage medium storing a program causing a computer to execute the information processing method according to any of techniques 1 to 6.

With this configuration, the same effects produced by the information processing method according to the aspect of the present disclosure can be produced.

### Supplementary Notes

An embodiment has been described above as an example of the techniques disclosed in the present application. The techniques in the present disclosure, however, are not limited to this, and may be applied to embodiments obtained by appropriately performing modification, replacement, addition, omission, or the like on the embodiment.

Examples of modifications in the present disclosure will be listed hereinafter.
(1) Although a control packet is assumed to occur immediately after a screen operation in the embodiment, in practice, there are cases where a schedule is set through a screen operation and a control packet occurs in accordance with the set schedule. A control packet, therefore, need not occur immediately after a screen operation. In this case, when a screen operation and a control packet are associated with each other, the association can be performed by recognizing a schedule setting screen and a set time.
(2) In the embodiment, when the variation of feature vectors associated with a specific control type ID included in the screen operation information table is larger than the threshold T, the control can be excluded from the control type ID to be associated while assuming that the control is unlikely to be associated with a screen operation. For example, as a method for calculating the variation, a mean squared error from a centroid of feature vectors to each feature vector can be used.
(3) In the embodiment, each component of the abnormality detection apparatus 100 may be implemented as a single chip using a semiconductor device such as an integrated circuit (IC) or a large scale integration (LSI) circuit, or a subset or all of the components may be integrated into a single chip. A method for integration is not limited to LSI, and a dedicated circuit or a general-purpose processor may be used, instead. A field-programmable gate array (FPGA), which can be programmed after an LSI circuit is fabricated, or a reconfigurable processor capable of reconfiguring connections and settings of circuit cells inside the LSI circuit maybe used. Furthermore, if a technology for integration that replaces LSI emerges due to advances in semiconductor technology or derivative technologies, integration of the functional blocks may be carried out using such a technology. Application of biotechnology or the like is also conceivable as a possibility.
(4) The abnormality detection apparatus 100 may be achieved as a single apparatus including all the components, or may be achieved by allocating the functions to a plurality of apparatuses and causing the plurality of apparatuses to operate in coordination with each other.
(5) Processing performed by a specific processing unit may be performed by another processing unit. Order of a plurality of processing steps may be changed, or a plurality of processing steps may be performed in parallel with each other.
(6) Each apparatus may use any communication standard, which is not particularly limited.
(7) Each component may be achieved by executing a software program that suits the component. Each component may be achieved when a program executer such as a CPU or a processor reads and executes a software program stored in a storage medium such as a hard disk or a semiconductor.
(8) Each component may be achieved by hardware. For example, each component may be a circuit (or an integrated circuit). These circuits may form a single circuit as a whole, or may be discrete circuits. These circuits may be general-purpose circuits or dedicated circuits.
(9) General or specific aspects of the present disclosure may be implemented as an apparatus, a system, a method, an integrated circuit, a computer program, a non-transitory computer-readable storage medium, such as a compact disc read-only memory (CD-ROM), or any selective combination thereof.
(10) A communication method employed between apparatuses in the embodiment is not particularly limited. A relay apparatus (a broadband router or the like) that is not illustrated may be used for the communication between apparatuses.

The present disclosure also includes modes obtained by modifying the embodiment in various ways conceivable by those skilled in the art and modes achieved by combining components and functions from different embodiments without deviating from the scope of the present disclosure.

The present disclosure can be used for an apparatus that detects abnormalities in packets.

What is claimed is:

1. An information processing method comprising:
receiving an operation for causing an operation apparatus to transmit a packet from a user using a graphical user interface displayed on the operation apparatus;
obtaining an operation image displayed on the operation apparatus at a time when the operation is received;
obtaining the packet flowing through a network; and
determining, on a basis of the obtained operation image, whether the obtained packet is abnormal.

2. The information processing method according to claim 1,
wherein the determining extracts a feature vector representing a feature of the operation image and determines, on a basis of feature vectors included in an image information table and the extracted feature vector, whether the obtained packet is abnormal, and
wherein the image information table is information indicating relationships between operations for causing the operation apparatus to transmit a packet and feature vectors representing features of images displayed on the operation apparatus at times when the operation apparatus receives the operations from the user using the graphical user interface displayed on the operation apparatus.

3. The information processing method according to claim 2,
wherein the determining determines that the obtained packet is abnormal if a distance to a feature vector, among a plurality of feature vectors included in the image information table, that is closest to the extracted feature vector, is larger than a predetermined threshold.

4. The information processing method according to claim 2,
wherein the plurality of feature vectors included in the image information table is each associated with a control type identifier indicating a type of packet associated with the feature vector, and
wherein, if variation of, among the plurality of feature vectors, one or more feature vectors associated with a same control type identifier is larger than a predetermined variation, the determining determines whether the obtained packet is abnormal without using the one or more feature vectors associated with the same control type identifier.

5. The information processing method according to claim 4,
wherein, if the variation of the one or more feature vectors associated with the same control type identifier is smaller than or equal to the predetermined variation, the determining determines whether the obtained packet is abnormal using the one or more feature vectors associated with the same control type identifier.

6. The information processing method according to claim 4,
wherein the determining calculates the variation of the one or more feature vectors by calculating an average of values obtained by raising distances of the one or more feature vectors associated with the same control type identifier from a centroid vector of the one or more feature vectors to a power of N (N is a real number larger than 0).

7. An information processing apparatus comprising:
a receiver that receives an operation for causing an operation apparatus to transmit a packet from a user using a graphical user interface displayed on the operation apparatus;
an obtainer that obtains an operation image displayed on the operation apparatus at a time when the operation is received;
another obtainer that obtains the packet flowing through a network; and
a determiner that determines, on a basis of the obtained operation image, whether the obtained packet is abnormal.

8. A non-transitory computer-readable storage medium storing a program causing a computer to execute the information processing method according to claim 1.
